(19) United States
(12) Patent Application Publication
(10) Pub. No.: US 2010/0112290 A1
(43) Pub. Date: May 6, 2010

(54) MATERIALS, SYSTEMS AND METHODS FOR MARKING A LOCATION OF BURIED ITEMS AND METHODS OF MAKING SUCH MATERIALS

(76) Inventors: Chad Barret, St. George, UT (US); James L. Fehrenbacker, LaVerkin, UT (US); Butch S. Roundy, LaVerkin, UT (US); Isaac B. Barlow, Centennial Park, AZ (US)

Correspondence Address: TRASKBRITT, P.C., P.O. BOX 2550, SALT LAKE CITY, UT, 84110, US

(21) Appl. No.: 12/433,470

(22) Filed: Apr. 30, 2009

Related U.S. Application Data
(60) Provisional application No. 61/049,644, filed on May 1, 2008.

(51) Int. Cl. B32B 3/00; C09D 5/00

(52) U.S. Cl. 428/156; 106/31.01

(57) ABSTRACT

Materials and systems for marking locations of an item buried below ground comprise a compactable material comprising a plurality of particles at least partially surrounds the item buried below ground. The compactable material has a selected color distinct which differs from a color of any adjacent earth material. Methods of marking the location of the buried item and methods of making the compactable material are also disclosed.

### CROSS-REFERENCE TO RELATED APPLICATIONS

The present application claims the benefit of U.S. Provisional Patent Application Ser. No. 61/049,644, filed May 1, 2008, the disclosure of which is incorporated herein by reference in its entirety.

### TECHNICAL FIELD

Embodiments of the present invention relate generally to articles buried below ground. More particularly, embodiments of the present invention relate to systems and methods of marking locations of buried articles.

### BACKGROUND

Items are often buried below ground for various purposes. For example, utilities that provide gas, electric, water, and/or telephone service bury their conveyances (e.g., pipes and/or cables) underground, both for reasons of safety and aesthetics. Conventionally, when burying such items below ground some system may be employed to indicate and/or warn of its location. For example, where appropriate, such utilities may provide one or more visual markers along the conveyance right-of-way, alerting those who might potentially excavate of the presence of such a buried conveyance. In some instances, a utility cannot place a sign or marker everywhere along the right-of-way of a buried utility conveyance. Instead, the utility must rely on regulations implemented by many jurisdictions that require contractors contact a central registry for buried utility conveyance information prior to excavation. Contractors that call the central registry receive information identifying buried conveyances in the area of desired excavation. Since the conveyance identity information is often general in nature, most utilities, in response to an inquiry received via the central registry, will dispatch one or more technicians to physically pin-point the buried conveyance to avoid damage by excavation.

In other instances, a thin ribbon or red caution tape is placed in the ground to alert those who might be actively excavating that they are near such a buried conveyance. Such a ribbon is typically only about two inches wide and may be difficult to find until it is too late and the item has been struck or damaged.

### BRIEF SUMMARY

Various embodiments of the present disclosure comprise materials for marking a location of an item buried below ground. In one or more embodiments, the material may comprise a compactable fill material comprising a plurality of particles. The compactable fill material may be configured to identify the presence of at least one nearby buried item and may include a distinct color which differs from a color of any adjacent earth material.

Additional embodiment of the present disclosure comprise systems for indicating the location of at least one buried item. One or more embodiments of such systems may comprise a compactable material at least partially surrounding the at least one buried item. The compactable surrounding material includes a selected color distinct from a color of an adjacent earth material.

Still other embodiments of the present disclosure comprise methods of marking the location of one or more buried items. One or more embodiments of such methods may comprise positioning at least one item into an opening extending below ground. A compactable material may be disposed at least over the at least one item. The compactable material may comprise a distinct color which differs from a color of any adjacent earth material.

In yet further embodiment, the present disclosure comprises methods of forming a compactable material. In one or more embodiments, such methods may comprise mixing a pigment with a fill material until the pigment is at least substantially evenly distributed over the fill material. The pigment may subsequently be dried on the fill material.

### BRIEF DESCRIPTION OF THE DRAWINGS

FIG. 1 illustrates a cross-sectioned view of an opening below ground comprising a system for marking a location of one or more items buried below ground according to at least one embodiment;

FIG. 2 is a cross-sectioned view of an opening below ground comprising a system for marking a location of one or more items buried below ground according to at least one embodiment;

FIG. 3A is a cross-sectioned view of an opening below ground comprising a system for marking a location of one or more items buried below ground according to at least one embodiment;

FIG. 3B is a cross-sectioned view of an opening below ground comprising a system for marking a location of one or more items buried below ground according to one or more embodiments;

FIG. 4 is a cross-sectioned view of an opening below ground comprising a system for marking a location of one or more items buried below ground according to one or more embodiments;

FIG. 5 is a cross-sectioned view of an opening below ground comprising a system for marking a location of one or more items buried below ground according to at least one embodiment

### DETAILED DESCRIPTION

The illustrations presented herein are, in some instances, not actual views of any particular trench, fill material, or buried item, but are merely idealized representations which are employed to describe the present invention. Additionally, elements common between figures may retain the same numerical designation.

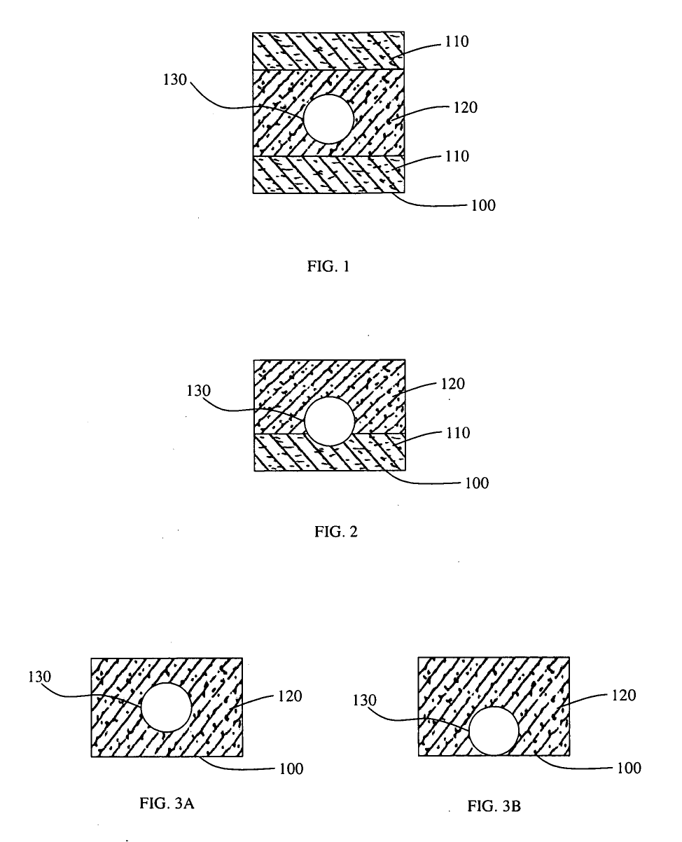

Various embodiments of the present disclosure comprise materials and systems for indicating the location of at least one buried item. Such a system may comprise a compactable material at least partially surrounding one or more buried items. FIG. 1 illustrates a cross-sectioned view of a system for marking a location of one or more items buried below ground according to at least one embodiment. The system of FIG. 1 comprises an opening 100 including a bottom layer of fill material 110, a layer of compactable material 120 (which may also be characterized as a surrounding compactable material or a surrounding material), at least one buried item 130 buried at least partially within or at least partially surrounded by the compactable material 120, and a top layer of fill material 110. The opening 100 may comprise a trench, hole or other opening which extends to some depth below the surface of the ground. The fill material 110 may comprise conventional compactable fill material known to those of ordinary skill in the art. Typical fill material 110 may comprise compactable sand, gravel, the ground material removed when making the opening 100, etc. The buried item 130 may comprise any item for which indication or warning of the items location and/or characteristics may be desired to a person who is subsequently digging in the area. By way of example and not limitation, the buried item 130 may comprise a utility line, septic system, time capsule, landfill, structure, footing, tank, barrel, or cistern. Non-limiting examples of utility lines may include a gas line, a water line, a telecommunications cable, a phone line, a sewer line, a power line, etc.

The compactable material 120 comprises a compactable fill material comprising a plurality of particles including a distinctive color. The distinctive color may be selected to provide identifying information about the buried item 130. In at least some embodiments, the distinctive color may comprise a pigment at least substantially evenly distributed over at least some of the particles comprising the compactable fill material. By way of example and not limitation, the pigment may be at least substantially evenly distributed over a percentage of the particles selected from the group consisting of 20%, 30%, 40%, 50%, 60%, 70%, 80% or 90%. The distinctive color may comprise a color selected to indicate some information relating to the buried item 130.

The compactable material 120 may comprise any of the conventional fill materials that may also be used for the fill material 110 described above. By way of example and not limitation, the compactable material 120 may comprise at least one of sand, gravel, silt, and clay. In at least one embodiment, the compactable material 120 may comprise compactable sand, at least a portion of which has been colored a particular color. The compactable material 120 is positioned to at least partially surround the buried item 130 (e.g., FIG. 2), and, in some embodiments, may fully surround the buried item 130 (e.g., FIG. 1). In some embodiments, the compactable material 120 may comprise a mixture comprising a first fill material having a desired color and a second fill material that is not color coded.

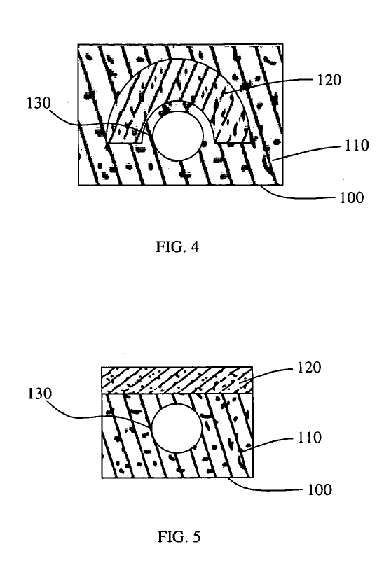

As illustrated in the embodiments depicted in FIGS. 1 and 3A, the compactable material 120 may be disposed in such a manner as to fully surround the buried item 130. In the embodiments illustrated, the compactable material 120 is adjacent to and contacts the buried item 130. In other embodiments in which the compactable material 120 fully surrounds the buried item 130, the compactable material 120 may not be adjacent to the buried item. In other words, according to some embodiments, fill material 110 may be positioned to surround the buried item 130, and then the compactable material 120 may be disposed over the fill material 110 and positioned to also fully surround the buried item 130.

In other embodiments, as depicted in FIGS. 2, 3B, 4 and 5, the compactable material 120 may only partially surround a portion of the buried item 130. As used herein, partially surrounding a portion of the buried item 130 refers to the compactable material 120 being disposed along or over a portion of at least one surface of the buried item 130. In some embodiments, the compactable material may be disposed adjacent to the buried item 130 and in other embodiments, the compactable material may be disposed over fill material 110 that is already disposed adjacent to the buried item 130.

The thickness of the compactable material 120 may be sufficient to provide adequate warning to a person digging in the earth within the proximity to the buried item 130 prior to actually contacting or penetrating the buried item 130. In various embodiments, the thickness of the compactable material 120 at its thinnest point, which in FIG. 1 would be in the vertical directions, may be between about 6 inches and 18 inches. In some embodiments, the thickness of the compactable material 120 at its thinnest point may be selected from the group consisting of about 0.5 inch, 1 inch, 2 inches, 3 inches, 4 inches, 5 inches 6, inches 7 inches, 8 inches, 9 inches, 10 inches, 11, inches, 12 inches, 13 inches, 14 inches, 15 inches, 16 inches, 17 inches, 18 inches, 19 inches, 20 inches, 21 inches, 22 inches, 23 inches or 24 inches. In further embodiments, the thickness of the compactable material 120 at its thinnest point may be up to 10 feet thick, or greater. However, the specific thickness of the compactable material may be determined based on the specific application.

In still other embodiments of systems for indicating the location of one or more buried items, as depicted in FIGS. 3A and 3B, the compactable material 120 may be disposed to at least substantially fill the entire opening 100 into which the buried item 130 is placed. In other words, the buried item 130 may be buried below ground using just the compactable material 120 to at least substantially fill the opening 100, and without using fill material 110. In such embodiments, the buried item 130 may be positioned such that the compactable material 120 fully surrounds the buried item 130, as shown in FIG. 3A, or the buried item 130 may be positioned at the bottom of the opening 100 with the compactable material 120 surrounding mostly the sides and top portions of the buried item, as illustrated in FIG. 3B.

In further embodiments of systems of the present disclosure, the compactable material 120 need not be adjacent to or in contact with buried item 130. In some embodiments, the compactable material 120 may be disposed over a fill material 110 that comprises a color different than the compactable material 120, the fill material 110 being disposed over the buried item 130. As shown in FIG. 4, the compactable material 120 may be placed so as to at least partially surround the buried item 130 without actually being adjacent to or in contact with the buried item 130. In other words, fill material 110 may be disposed over at least a portion of the buried item 130, and the compactable material 120 may be disposed over the fill material 110. In some embodiments, the fill material 110 may be disposed to a thickness between about 6 inches and about 12 inches over the buried item 130. In other embodiments, the fill material 110 may be disposed to a thickness selected from the group of thicknesses consisting of about 0.5 inch, 1 inch, 2 inches, 3 inches, 4 inches, 5 inches 6, inches 7 inches, 8 inches, 9 inches, 10 inches, 11, inches, 12 inches, 13 inches, 14 inches, 15 inches, 16 inches, 17 inches, 18 inches, 19 inches, 20 inches, 21 inches, 22 inches, 23 inches or 24 inches. In further embodiments, the thickness of the fill material 110 at its thinnest point may be up to 10 feet.

In another embodiment, the compactable material 120 may be placed as a layer located to one or more sides of the buried item 130, the layer being disposed over a layer of the fill material 110 that is disposed adjacent to the buried item 130, as depicted in FIG. 5. In some embodiments, the fill material 110 may be disposed to a thickness between about 6 inches and about 12 inches over the buried item 130. In other embodiments, the fill material 110 may be disposed to a thickness selected from the group of thicknesses consisting of about 0.5 inch, 1 inch, 2 inches, 3 inches, 4 inches, 5 inches 6, inches 7 inches, 8 inches, 9 inches, 10 inches, 11, inches, 12 inches, 13 inches, 14 inches, 15 inches, 16 inches, 17 inches, 18 inches, 19 inches, 20 inches, 21 inches, 22 inches, 23 inches or 24 inches. In further embodiments, the thickness of the fill material 110 at its thinnest point may be up to 10 feet. Although the compactable material 120 is illustrated in FIG. 5 as comprising the top layer of fill material filling the opening 100, such embodiments are not so limited. For example, additional fill material 110 may be disposed over the compactable material 120 shown in FIG. 5, the compactable material 120 may fill only a portion of the width of the opening 100 with fill material 110 filling the remaining width, as well as other similar variation. Those of ordinary skill in the art will recognize that a number of configurations of fill material 110 and compactable material 120 are possible.

The compactable material 120 may be colored, painted or dyed in any manner known to those of ordinary skill in the art. In one embodiment, the compactable material 120 may be formed by mixing the pigment or dye material with the fill material, such as sand, to evenly distribute the color over the fill material. One method may include combining the fill material and the pigment in a mixing drum and rotating the drum until the pigment is evenly distributed over the fill material. For example, a mixing drum, such as a 10-yard mixing drum, may be employed and filled with the proper ratio of pigment and fill material, and the drum may be rotated for an appropriate time to evenly coat the pigment over the fill material. In at least some embodiments, the drum is rotated for approximately 15 minutes. One non-limiting example of a proper ratio of pigment to fill material may comprise 0.4 pounds of liquid color to 100 pounds of fill material. The pigment may be air dried, especially in a warmer climate, or the pigment may be dried by heating the fill material, such as with a heated conveyor.

In another embodiment, the pigment may be sprayed onto the fill material. By way of example, the fill material may be placed on a conveyor belt and the pigment sprayed onto the fill material. Care may be taken to rotate the fill material to provide for an even distribution of pigment over and proper penetration into the fill material.

The pigment may be selected to adhere to the fill material so as to reduce or eliminate fading of the color and/or bleeding of the pigment into the surrounding environment. Furthermore, the material may be selected for environmental safety. By way of example and not limitation, the pigment may comprise an organic pigment or an iron oxide pigment, such as the aggregate colorant manufactured by Prism Pigments® of St. Paul, Minn. The color of the pigment may depend on the specific application. For example, conventional colors may be used to identify specific utility lines as are known to those of ordinary skill in the art. By way of example, red may be used to indicate a power line, blue for water, and yellow for gas, etc. Such colors are conventionally employed to indicate the specific utility line and may be used to color the compactable material 120 for use with one of those specific utility lines.

Additional embodiments of the present disclosure are directed to methods of marking the location of a buried item 130. According to at least one embodiment, a method of marking the location of a buried item 130 may comprise positioning at least one item into an opening formed to extend below ground level. The compactable material 120 comprising the distinctive color may be disposed at least over a portion of the buried item 130.

In some embodiments, the compactable material 120 may be disposed as a layer within the opening 100 to a desired thickness. The buried item 130 may be positioned in the opening 100 over the layer of compactable material 120 and additional compactable material 120 may be disposed in the trench to at least substantially surround the buried item 130. In other embodiments, the buried item 130 may be positioned on the bottom of the opening 100 without any significant amount of compactable material 120 therein. The compactable material 120 may then be disposed over and around the buried item 130 to a desired thickness. If necessary, a final or top layer of fill material 110 may be disposed over the compactable material 120 to finish filling the opening 100.

In still other embodiments, a base layer of fill material 110 may be disposed at the bottom of the opening 100. The buried item 130 may be positioned on top of the base layer of fill material 110, and compactable material 120 may be disposed over and around the buried item 130 to at least substantially surround the buried item 130. In one embodiment, a layer of compactable material 120 may be disposed over the base layer of fill material 110 prior to positioning the buried item 130 within the opening 100. The buried item is, therefore, positioned on the layer of compactable material 120 and then additional compactable material 120 is disposed over and around the remaining portions of the buried item 130.

In yet other embodiments, the buried item 130 may be positioned in the opening 100, either at the bottom or on a layer of fill material 110. Fill material 110 may be disposed over at least a portion of the buried item 130. Subsequently, a layer of the compactable material 120 may be disposed over the fill material 110. In some embodiments, the fill material 110 may be disposed over the buried item 130 to a thickness of between about 6 inches and about 12 inches. In other embodiments, the fill material 110 may be disposed to a thickness selected from the group of thicknesses consisting of about 0.5 inch, 1 inch, 2 inches, 3 inches, 4 inches, 5 inches 6, inches 7 inches, 8 inches, 9 inches, 10 inches, 11, inches, 12 inches, 13 inches, 14 inches, 15 inches, 16 inches, 17 inches, 18 inches, 19 inches, 20 inches, 21 inches, 22 inches, 23 inches or 24 inches. In further embodiments, the thickness of the fill material 110 at its thinnest point may be up to 10 feet. In some embodiments, the compactable material 120 may be disposed over the fill material 110 with a thickness of at least about 0.5 inch. In other embodiments, the compactable material 120 may be disposed to a thickness selected from the group of thicknesses consisting of about 0.5 inch, 1 inch, 2 inches, 3 inches, 4 inches, 5 inches 6, inches 7 inches, 8 inches, 9 inches, 10 inches, 11, inches, 12 inches, 13 inches, 14 inches, 15 inches, 16 inches, 17 inches, 18 inches, 19 inches, 20 inches, 21 inches, 22 inches, 23 inches or 24 inches. In further embodiments, the thickness of the compactable material at its thinnest point may be up to 10 feet.

While certain embodiments have been described and shown in the accompanying drawings, such embodiments are merely illustrative and not restrictive of the scope of the invention, and this invention is not limited to the specific constructions and arrangements shown and described, since various other additions and modifications to, and deletions from, the described embodiments will be apparent to one of ordinary skill in the art. Thus, the scope of the invention is only limited by the literal language, and equivalents, of the claims which follow.

What is claimed is:

1. A material for marking a location of an item buried below ground, the material comprising:
a compactable fill material comprising a plurality of particles;
wherein the compactable fill material is configured to identify the presence of at least one nearby buried item; and
wherein the compactable fill material includes a distinct color which differs from a color of any adjacent earth material.

2. The material of claim 1, wherein the compactable fill material comprises a material selected from the group of materials consisting of sand, gravel, silt, and clay.

3. The material of claim 1, wherein the distinct color comprises a pigment at least substantially evenly distributed over at least some of the particles comprising the compactable fill material.

4. The material of claim 1, wherein the distinct color comprises a pigment at least substantially evenly distributed over at least a majority of the particles comprising the compactable fill material.

5. The material of claim 1, wherein the distinct color comprises a color selected to indicate the purpose of the at least one buried item.

6. The material of claim 1, wherein the distinct color comprises a pigment configured to reduce bleeding of the pigment into the surrounding environment.

7. The material of claim 1, wherein the at least one buried item is selected from the group consisting of a water line, a telecommunications cable, a phone line, and a power line.

8. The material of claim 1, wherein a thickness of the compactable fill material at a thinnest point is at least about 2 inches.

9. A system for indicating the location of at least one buried item, the system comprising a compactable material at least partially surrounding at least one buried item, the compactable material having a selected color distinct from a color of an adjacent earth material.

10. The system of claim 9, further comprising:
a bottom layer of fill material below the compactable material; and
a top layer of fill material over the compactable material.

11. The system of claim 9, wherein the at least one buried item comprises a utility line selected from the group consisting of a water line, a telecommunications cable, a phone line, and a power line.

12. The system of claim 9, wherein the compactable material comprises a mixture of a first fill material having the selected color and a second fill material not having the selected color.

13. The system of claim 9, wherein the compactable material comprises at least one material selected from the group of materials consisting of sand, gravel, silt, and clay.

14. The system of claim 9, wherein a thickness of the compactable material at a thinnest point is at least about 2 inches.

15. A method of marking the location of a buried item, comprising:
positioning at least one item into an opening extending below ground; and
disposing a compactable material at least over the at least one item, the compactable material comprising a distinct color.

16. The method of claim 15, wherein positioning the at least one item below ground comprises positioning the at least one item selected from the group consisting of a water line, a telecommunications cable, a phone line, and a power line below ground.

17. The method of claim 15, wherein disposing the compactable material at least over the at least one item comprises:
disposing a fill material comprising a color different than the compactable material over the at least one item; and
disposing the compactable material over the fill material.

18. The method of claim 17, wherein disposing the fill material over the at least one item comprises disposing the fill material over the at least one item to a thickness selected from the group of thicknesses consisting of 0.5 inch, 1 inch, 2 inches, 3 inches, 4 inches, 5 inches 6, inches 7 inches, 8 inches, 9 inches, 10 inches, 11, inches, 12 inches, 13 inches, 14 inches, 15 inches, 16 inches, 17 inches, 18 inches, 19 inches, 20 inches, 21 inches, 22 inches, 23 inches or 24 inches.

19. The method of claim 15, wherein disposing the compactable material comprises disposing the compactable material with a thickness of at least about 2 inches.

20. The method of claim 15, wherein disposing the compactable material at least over the at least one item comprises disposing the compactable material at least partially surrounding the at least one item.

21. The method of claim 20, wherein disposing the compactable material at least partially surrounding the at least one item comprises:
disposing a portion of the compactable material into an opening;
positioning the at least one item in the opening over the portion of the compactable material; and
disposing additional compactable material over the at least one item to at least substantially cover the at least one item.

22. The method of claim 20, wherein disposing the compactable material at least partially surrounding the at least one item comprises:
disposing a base layer of a fill material comprising a color different than the compactable material below the compactable material; and
disposing a top layer of the fill material over the compactable material.

23. The method of claim 15, wherein disposing the compactable material at least over the at least one item comprises disposing the compactable material at least partially adjacent to the at least one item.

24. A method of forming a compactable material, comprising:
mixing a pigment with a fill material until the pigment is at least substantially evenly distributed over the fill material; and
drying the pigment on the fill material.

25. The method of claim 24, wherein mixing the pigment with the fill material comprises:
combining the pigment in a liquid form and the fill material in a mixing drum; and
rotating the mixing drum.

26. The method of claim 24, wherein mixing the pigment with the fill material comprises spraying the pigment onto the fill material.

27. The method of claim 24, wherein mixing the pigment with the fill material comprises mixing the pigment with the fill material comprising at least one material selected from the group of materials consisting of sand, gravel, silt, and clay.

28. The method of claim 24, wherein mixing the pigment with the fill material comprises mixing at least one of an organic pigment and an iron oxide pigment with the fill material.

29. The method of claim 24, wherein mixing the pigment with the fill material comprises mixing a pigment resistant to bleeding with the fill material.
